(19) United States
(12) Patent Application Publication
(10) Pub. No.: US 2016/0051439 A1
(43) Pub. Date: Feb. 25, 2016

(54) VIBRATING PAIN RELIEF MASK

(71) Applicant: BROWNMED, INC.,, Spirit Lake, IA (US)

(72) Inventors: Ivan E. Brown, Spirit Lake, IA (US); Teryle L. Kounkel, Spirit Lake, IA (US); Brandon Rodriguez, Spirit Lake, IA (US)

(21) Appl. No.: 14/464,762

(22) Filed: Aug. 21, 2014

(51) Int. Cl. A61H 23/02; A61H 21/00

(52) U.S. Cl. CPC A61H 23/02; A61H 21/00

(57) ABSTRACT

An eye mask containing a loose filling of beads and an electro-massaging unit positioned in the mask to provide vibratory massage to a user's eye, nose and to the loose filling of beads.

### FIELD OF THE INVENTION

This invention relates to a therapeutic eye mask that provides pain relief through application of vibratory therapeutics around the eye sockets sinus cavity, nose, and in general provides comfort and some relief for things such as sinus congestion, migraines, normal headaches, puffy eyes, and the like.

### BACKGROUND OF THE INVENTION

This invention represents an improvement over commonly owned eye pillow patent U. S. Pat. No. 7,601,168, which provides no vibratory therapeutics. U. S. Pat. No. 7,601,168 is incorporated herein by reference.

People suffering from migraine and other headaches, sinus pain, tired and puffy eyes, etc., are often in need of therapeutic relief without the use of drugs. It is therefore desirable to provide options which avoid drug use and which provides a soothing calming feeling, both for therapeutic affect and for its ability to calm and distract one from concentrating on pain.

It has now been discovered that the use of a compression eye mask in combination with vibrating motors enhances the communication of the vibration, especially when the eye mask is filled with loose bead material, preferably ergobeads. The loose beads as a consequence of the vibration caused by the vibrating motors, migrate throughout the mask providing a gentle soothing enhanced therapy.

It is a primary objective of the present invention therefore to achieve the relief provided by the compression, vibratory mask here described.

### SUMMARY OF THE INVENTION

The present invention is directed to an eye mask worn by a user to provide soothing comfort and relief. The eye mask is formed of a pair of opposed fabric sheets or panels that are joined together. The sheets form opposed sides of the eye mask. A filling material such as a plurality of beads or pellets is packed between the fabric panels. Each of the opposed sides of the eye mask is therefore conformable to a user's eye socket and nose anatomy. The beads may be oval, elliptical or round in shape and may include a dimple. The surfaces of the beads are very smooth, enabling them to slide against each other freely and thus provide easy deformability of the eye mask. This enables it to easily conform to a user's face. The fabric panels of the eye mask provide comfort to the wearer and may be formed of a material that is elastically resilient in character. The bead filling is itself vibrated along with a user's eye sockets and sinus cavities by electro-therapy units mounted in the mask.

### BRIEF DESCRIPTION OF THE DRAWINGS

FIG. 1 is a perspective view of an exemplary eye mask of the invention.

FIG. 2 is a sectional view along line 2-2 of FIG. 1 showing that the mask is filled loosely with beads, preferably ergobeads.

FIG. 3 is a front view of one of the panels with its covering and beads removed showing the schematic details of the mounting of the vibratory electro-massage unit, including the motors, chargeable battery, and off/on switch.

### DETAILED DESCRIPTION OF THE PREFERRED EMBODIMENTS

The present invention is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity Like numerals denote like features throughout the specification and drawing.

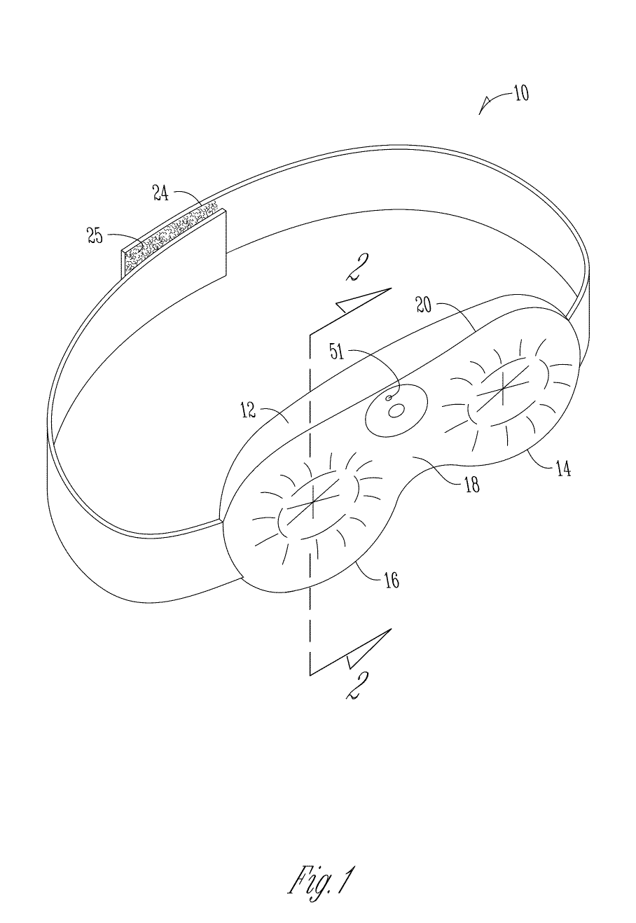

The present invention provides an eye mask that prevents and/or treats sinus, migraine and other headaches, soothes tired and puffy eyes, blocks out light and provides soothing and calming vibration therapy to the user. The eye mask covers and peripherally surrounds the eye region when worn by the user. An exemplary eye mask embodiment is illustrated in FIG. 1. In other exemplary embodiments, the eye mask may be larger in size and extend further to cover further peripheral portions of the user's face and head.

The eye mask 10 is formed of opposed comfortable fabric surfaces (i.e., the “sides”) and is filled with a filling material. In one embodiment, the opposed surfaces may be a set of equally sized panels that are peripherally joined such as by stitching or other suitable means. FIG. 1 shows eye mask 10 which includes a generally level top 12 and a downwardly extending lobes 14, 16. In other embodiments, the eye mask 10 may have different shapes. The anatomic shape of eye mask 10 allows it to conform to the user's face, eyes and nose. The embodiment of FIG. 1 illustrates a continuous single panel 18 that forms one side, i.e., one surface of the eye mask 10. It will be shown that a similar panel is formed on the other side of eye mask and that the panels are peripherally joined to form a pouch area. The surface 20 may be formed of multiple panels, i.e., another piece of like fabric covering the electro-massage unit (FIG. 3) as a surface panel 54.

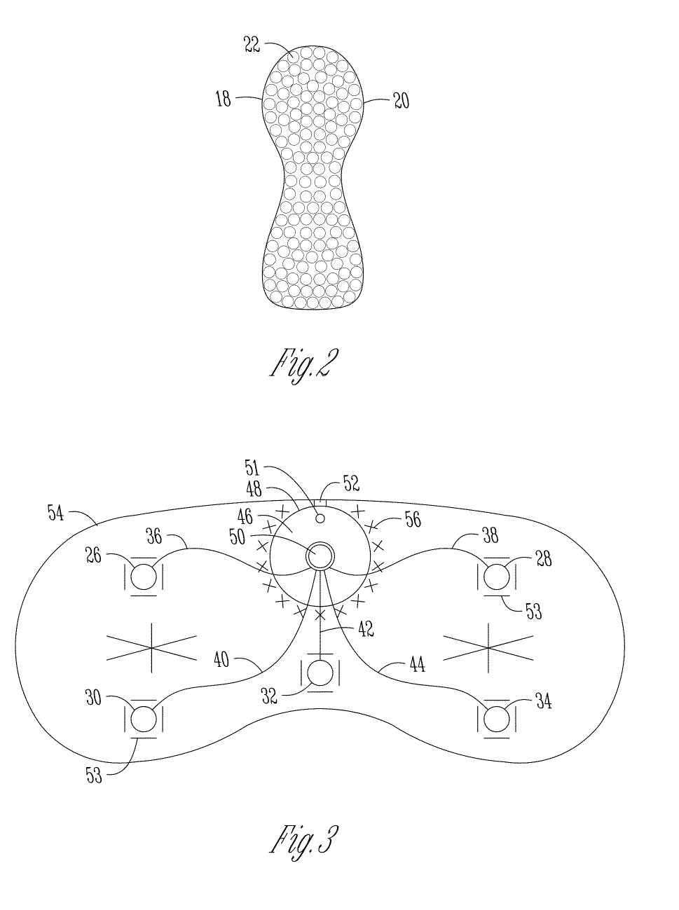

As seen in FIG. 2, the eye mask 10 with its two panels 18 and 20 defines an interior pocket which is loosely filled with bead material 22 to create a sort of sand bag affect. This allows the mask 10 to fit snuggly around the face when held on by stretchable strap 24, closed by Velcro, 25. The loose bead material 22 naturally fills in the bumps and depressions around the eye socket and nose. In short, it comfortably fits the user's anatomy.

FIG. 3 depicts a plan view of the interior surface of one of the panels with its surface cover removed so that the electrical schematic may be illustrated.

As best illustrated in FIG. 3 electrical vibrating therapy is provided by five individual vibrating motors 26, 28, 30, 32 and 34 which are electrically connected by wires 36, 38, 40, 42 and 44 to power source such as battery 46. Battery 46 is inside of plastic housing 48 and carries an on/off switch 50 and has a charger plug in 51. The electrical assembly of FIG. 3 is placed in mating relationship with and on top of, the panel 20 as illustrated in FIG. 3. It is covered over with a like-shaped overlay panel 54 of the same stretchable fabric material as panel 20. The overlay 54 is stitched to panel 20 and prevents direct contact with the beads 22 and motors 26-34.

In operation the mask 10 is used in the following manner. A wearer puts on her mask 10, and instantly feels the hugging compression over all parts of her forehead and around the eyes. The individual vibrating motors 26 to 34 are compressed against the periphery of the eye cavity and nose as well as against the beads 22. The battery 46 is then in a position about the equivalent to just between the eyes. On/off switch 50 is then turned on to activate the motors 26 to 34, and vibration therapy begins. Because of the compression, the vibration is felt well beyond the position of motors 26 to 34, namely carrying rearward in the eye socket and the bridge of the nose to the sinus cavities. The beads 22 vibrate and even move making the vibrations felt throughout the mask 10. To stop the vibration the on/off button 50 is again pressed.

Certain constructional features are worthy of specific mention. The housing of the vibrating motors 26 to 34 is integral with the connecting lead wire. This is to prevent or minimize the fatigue associated with the thin wire in an active range of motion of the mask 10. The mask 10 with its stretchable fabric, preferably about 92% cotton and about 8% spandex, permits significant stretch, provides continuous orthotic compression and does not compromise memory nor the non-stretch wires that connect the switch and the motors. Straight stitch 52 holds the motors 26 to 34 in place and decreases migration of the motors within the structure of the mask 10 itself as worn. Vibration does normally induce migration so the straight stitch 53 technique holds the individual motors in place. The battery 46 also has a horseshoe stitch 56 which functions to keep this housing 48 from migration. This is important otherwise the on/off switch 50 would move. Battery 46 can have a silicone cover to help further reduce migration.

Importantly, the mask and beads use a stretchable material for the pouch panels which helps communicate the vibration all around the forehead. Compression also helps retain the value of the therapy for a longer period of time.

If desired a Piezo electric vibration generator may be used to replace the motors.

Motors 26 to 34 and battery 46 are available from a variety of sources. An example, one suitable supplier is Shenzhen Jingkefa Electronics Co. Limited. Batteries suitable for the vibrating motors 26 to 34 are a 3.7 volt lithium ion battery, which is rechargeable.

The use of a compression eye mask 10 combination with the vibrating of motors 26 to 34 enhances communication of vibration. The loose ergobead 22 filling amplifies the vibration generated by the vibrating motors giving the effect of stable vibration throughout the mask 10. The loose beads 22 also, migrate throughout the mask which provides a gentle, soothing effect.

Unlike traditional massage, the compression vibrating pain relief mask 10 provides a combination of compression and continuous topical vibration to stimulate circulation in a targeted region. With consistent and targeted stimuli, the value of the vibration is retained longer than a traditional massage because the mask results in retention of the feeling of the vibration longer as circulation is activated in the specific region. This is the same reasons speed runners or swimmers wear full body suites. The suits help maximize the value of muscle expenditure, which improves efficiency. And so here the retention of the value of vibration also helps to increase release of body toxins in head cavities over a longer period of time, and thus further enhances the wellness factor.

In addition, it has been noted by some patients that wearing of the mask on a regular basis helps relieve headaches, migraines, the pain from sinus infections, assists in improving dry eye syndrome relief and generally provides help and relief from stress and tension even from non-sufferers of eye or sinus diseases. It may also help provide relief from eye strain and dark circles and puffy eyes which are commonly caused by small capillaries around the eye leaking from weakness which causes hemoglobin to pool around the eyes thus giving the dark circle appearance. Some have noted the massage gently removes clogged lymph debris away from the areas so that the body can then flush pooled material from around the eyes.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawings, which are to be considered part of the entire written description. In the description, relative terms such as “lower,” “upper,” “loosely,” “above,” “below,” “up,” “down,” “top,” “bottom,” etc. are used. These should be construed to refer to the orientation as then described or as shown in the drawing under discussion. These relative terms are for convenience of description and do not require that the device be constructed or operated in a particular orientation.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An eye mask, comprising:
a pair of fabric panels each having an interior surface and an exterior surface, joined to form a closed pouch;
a plurality of beads substantially filling said pouch; and
an electro-vibration unit mounted on the interior surface of at least one of said panels.

2. The eye mask of claim 1 wherein the electro-vibration unit comprises a rechargeable power source, electrically connected to motors positioned on the interior surface of one of the said panels.

3. The eye mask of claim 1 wherein the electro-vibration unit is mounted on the interior surface of the one of said panels that would normally contact a user's eye.

4. The eye mask of claim 1 wherein the pair of fabric panels are stretchable and/or about 92% cotton, about 8% spandex.

5. The eye mask of claim 1 wherein the mask has an on/off switch associated with said electro-vibration unit.

6. The eye mask of claim 3 wherein the interior surface of the one of said eye panels that would normally contact the user's eye has a layer of stretchable fabric covering its electro-vibration unit.

7. The eye mask of claim 6 wherein motors are positioned to provide vibration to each of a user's eyes.

8. The eye mask of claim 7 wherein at least one motor is positioned to provide vibration to a user's olfactory nerve.

9. The eye mask of claim of claim 8 wherein the beads are ergobeads.

10. In an eye mask comprising:
a filling of loose beads, the improvement comprising an electro-massage unit positioned to provide vibratory therapy to a user's eye and vibration to the loose filling of said beads.

11. The eye mask of claim 10 wherein the beads are ergobeads.
